(19) United States
(12) Patent Application Publication
(10) Pub. No.: US 2005/0238949 A1
(43) Pub. Date: Oct. 27, 2005

(54) Reserve battery

(76) Inventors: William F. Morris, Mystic, CT (US); Julio Solorzano, Wake Forest, NC (US); Tsepin Tsai, Chappaqua, NY (US); Cheng Ming Lee, Taiwan (CN); Austin Hsu, Taiwan (CN); Louis Wan, Taiwan (CN); Jin-Hung Hsu, Taiwan (CN); Gary Chu, Taiwan (CN)

Correspondence Address: REVEO, INC., 3 WESTCHESTER PLAZA, ELMSFORD, NY, 10523, US

(21) Appl. No.: 10/500,946

(22) PCT Filed: Jan. 8, 2003
(86) PCT No.: PCT/US03/00473

§ 371 Date: May 25, 2005

Related U.S. Application Data
(60) Provisional application No. 60/346,467, filed on Jan. 8, 2002.
(60) Provisional application No. 60/383,746, filed on May 28, 2002.
(60) Provisional application No. 60/403,605, filed on Aug. 14, 2002.
(60) Provisional application No. 60/403,521, filed on Aug. 14, 2002.

(51) Int. Cl. H01M 6/36; H01M 12/06

(52) U.S. Cl. 429/113; 29/623.1

(57) ABSTRACT

Provided herein is a structure for use in an electrochemical cell system. The structure includes a dry component housing (180) including a plurality of dry components (110), including an anode (112) and a cathode (132). One end of the dry component housing comprises an electrolyte concentrate (solid or liquid) reservoir (150). The electrolyte concentrate reservoir and the dry components are in fluid communication via a flow control device (170), aperture (172) or system (170a). An electrochemical cell is formed using the structure, in addition to a source (262). When the water is added in the proximity of the electrolyte concentrate reservoir, diluted electrolyte is introduced through an electrolyte flow control device, structure or system, the cell is activated.

### BACKGROUND OF THE INVENTION

A reserve battery is one in which electrolyte is maintained in isolation from one or more electrodes of the battery. Thus, the battery is inactive when stored, and activated when the electrodes and electrolyte are brought into ionic contact. Since there is no consumption or reaction with the electrodes under these circumstances, the shelf life is essentially infinite.

For many applications, where a high voltage is required, many batteries are combined to provide the requisite power needs. Moreover, many applications require relatively instantaneous activation. Prior attempts to maintain electrodes and electrolyte out of contact include: structures where one electrode (e.g., zinc) is inserted into a structure with electrolyte and an opposite electrode (e.g., carbon); removing a liner between electrolyte and electrode(s); tilt action of the cell, whereby electrolyte moves into contact with one or more electrodes; pouring or dumping electrolyte; and forcing electrolyte forced into an annular gap between the electrodes, in cylindrical cells.

One problem encountered in many of the known reserve batteries relates to the ramp up voltage of the cells. This is influenced by the speed and uniformity of the interaction of the electrolyte and electrodes.

Another problem in many types of batteries, including reserve batteries, relates to fluid or electrolyte leakage. This raises sanitary and safety concerns, especially where a strong acidic or caustic electrolyte is used.

Therefore, a need remains in the art for an improved reserve battery with rapid and uniform electrolyte introduction that resists electrolyte leakage.

### SUMMARY OF THE INVENTION

Therefore, the present invention provides a deferred action dry cell which undergoes substantially no deterioration during storage, is rendered active by simply adding water, and delivers full power with minimal delay.

Provided herein is a structure for use in an electrochemical cell system. The structure includes a dry component housing including a plurality of dry components, including an anode and a cathode. One end of the dry component housing comprises an electrolyte concentrate (solid or liquid) reservoir. The electrolyte concentrate reservoir and the dry components are in fluid communication via a flow control device, aperture or other type of flow control system.

An electrochemical cell is formed using the structure, by addition to a source of water or other suitable liquid. When the liquid is added in the proximity of the electrolyte concentrate reservoir, diluted electrolyte is introduced through an electrolyte flow control device, structure or system, and the cell is activated.

Further, an electrochemical cell kit is formed, comprising the structure, in addition to a bottle or tube containing water or other suitable liquid.

### BRIEF DESCRIPTION OF THE DRAWINGS

FIG. 1A is an exploded isometric view of one embodiment of a set of dry components for a reserve electrochemical cell system;

FIG. 1B is an exploded isometric view of another embodiment of a set of dry components for a reserve electrochemical cell system;

FIGS. 1C(i) and 1C(ii) are exploded isometric views of a further embodiment of a set of dry components for a reserve electrochemical cell system;

FIG. 1D is another embodiment of an inner dry component portion;

FIG. 1E is still another embodiment of an inner dry component portion;

FIG. 2 is an isometric view of assembly of a dry component structure including a cathode structure;

FIG. 3A is an isometric view of an assembled dry component structure;

FIG. 3B is a front view of the assembled dry component structure of FIG. 3A;

FIG. 3C is a view of the assembled dry component structure of FIG. 3A showing the cathode current collector;

FIG. 3D is a view of the assembled dry component structure of FIG. 3A showing anode access openings;

FIGS. 4A, 4B and 4C depict a dry component structure in relation to an electrolyte reservoir portion;

FIGS. 5A(i) to 5A(iii) depict bottom isometric, top isometric, and top plan views of an exemplary electrolyte reservoir portion;

FIGS. 5B(i) to 5B(ii) depict top isometric and top plan views of another exemplary electrolyte reservoir portion;

FIGS. 5C(i) to 5C(ii) depict an enlarged view and a top isometric view of another exemplary electrolyte reservoir portion including a pressure release plug;

FIGS. 6A-6E show various embodiments of electrolyte flow control devices, structures or systems;

FIGS. 6F shows a tube of a flexible material (e.g., flexible plastic) with one or more cracks on the peripheral wall;

FIG. 6G(i) and 6G(ii) show a flexible bottle having an elongated hollow tube for introducing liquid into a reserve electrochemical cell;

FIGS. 6H(i) and 6H(ii) shows an embodiment of a fluid reservoir;

FIG. 7A shows an assembly of cells as described herein;

FIGS. 7B-7E depict various steps in integrally forming an assembly of cells;

FIG. 8A depicts a cell assembly prior to forming a molded support structure;

FIG. 8B depicts a cell assembly after to forming a molded support structure; and

FIGS. 9A-9C show closed, open and exploded views of a portable power supply system utilizing the reserve battery described herein;

### DETAILED DESCRIPTION OF A PREFERRED EMBODIMENT

The present invention is related to a reserve battery, particularly a metal air electrochemical cell in the configuration of a reserve battery. Various novel features are disclosed herein to improve operability and reliability as compared to conventional reserve batteries.

In general, the reserve metal air electrochemical cell described herein includes a dry component structure including a plurality of dry components. The dry components including an anode (generally a metal fuel anode) and a cathode, particularly an air diffusion cathode. One end of the dry component structure includes a reservoir of electrolyte concentrate. When activation is desired, water or another suitable liquid is added to the reservoir of electrolyte concentrate, whereby diluted electrolyte is introduced into the dry component structure through an electrolyte flow control structure, thereby causing electrochemical reaction between the anode and cathode.

Having generally described operation of the reserve battery described herein, various embodiments of the components of the cell will be described hereinafter.

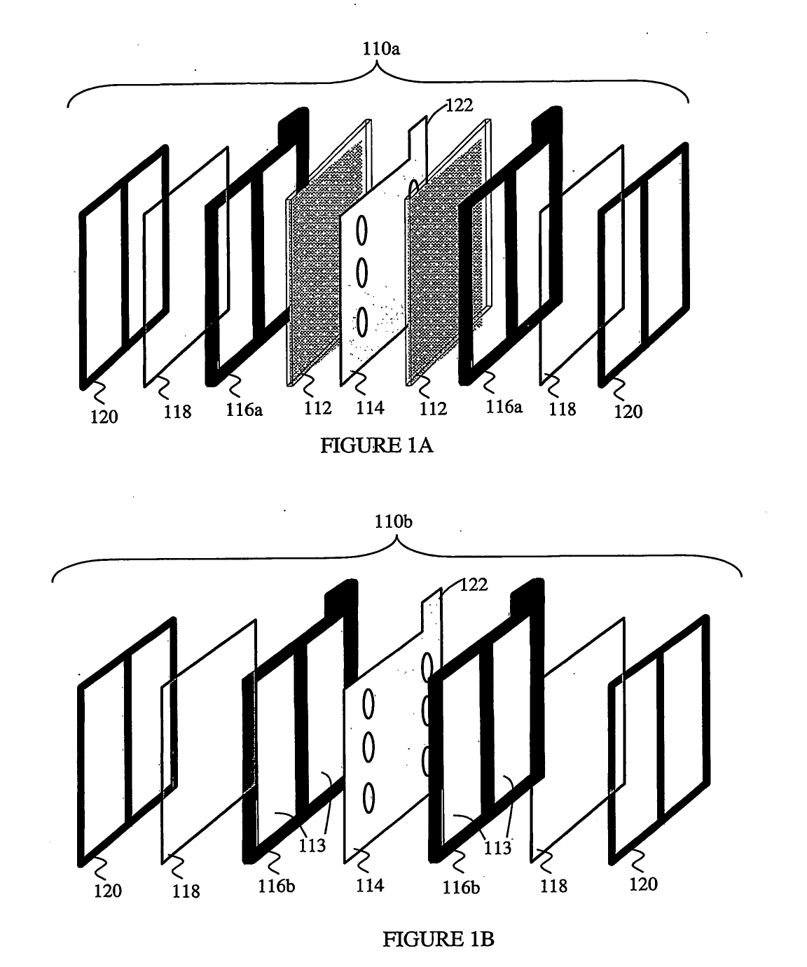

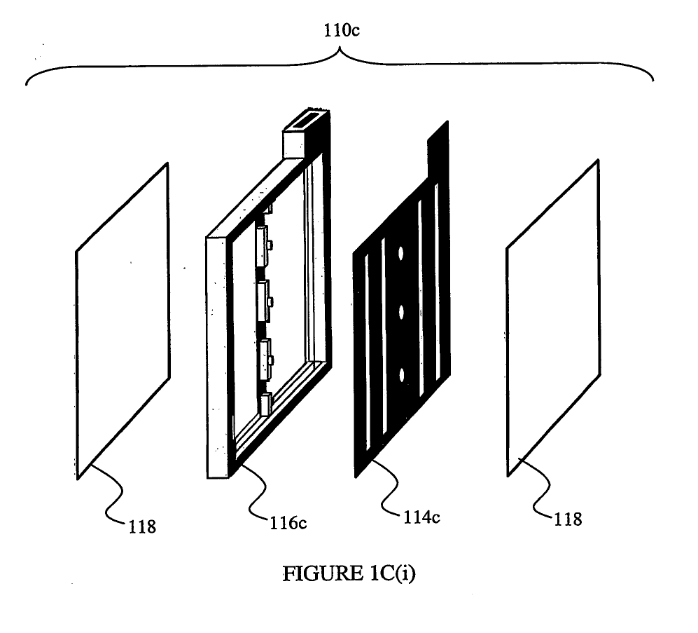

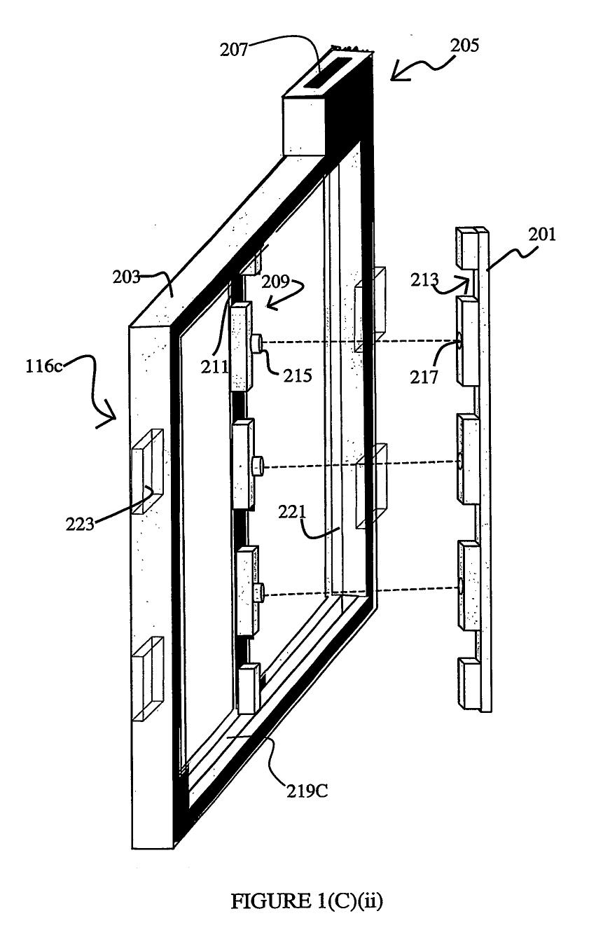

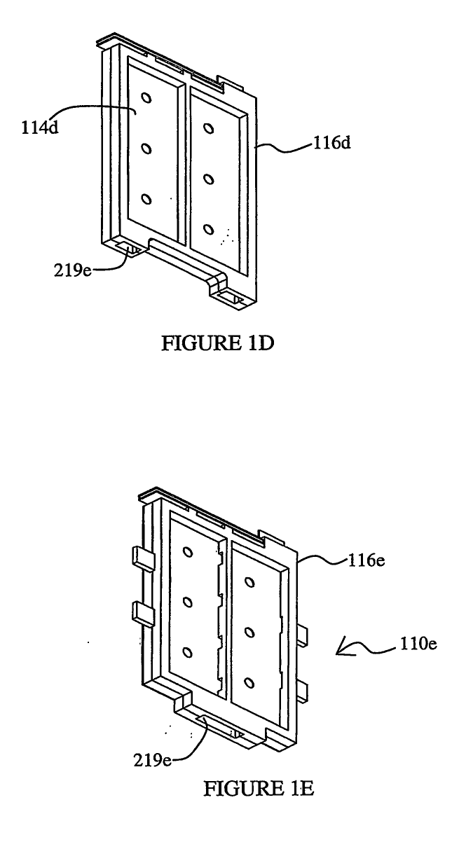

Referring now to FIGS. 1A, 1B, and 1C(i)-1C(ii), embodiments of a portion of a dry component structure are depicted. FIG. 1A shows an inner dry component portion 110a, FIG. 1B shows an inner dry component portion 110b, and FIGS. 1C(i)-1C(ii) show an inner dry component portion 110c. One difference between portions 110a, 110b and 110c is that portion 110a includes and an anode in the form of a consumable metal card, whereas portion 110b and 110c includes spaces 113 wherein consumable metal fuel material may be included after assembly of portion 110b or 110c, or at a later stage. Portion 110c further differs from portion 110a and 110b in that portion 110c includes an integral frame portion 116c. Furthermore, portion 110c includes guide bosses 223, used to facilitate assembly of plural dry component portions, as described further herein. Description of the inner dry component portion with respect to other components and embodiments described hereinafter will be referred to as the inner dry component portion 110, or portion 110.

Inner dry component portion 110a and 110b include a central anode current collector 114 surrounded by symmetrical sets of the following components: an anode 112, or voids 113, as described above; frame portions 116a or 116b; separators 118; and frames 120. Note that while two separate separator portions are depicted, a single separator may also be provided, for example, enveloping the inner frame portions and the metal fuel anode (whereby the optional outer frames 120 may me assembled over the separator). The anode current collector 114 further includes a negative terminal portion 122.

Portion 110a includes frame portions 116a accommodated to fit the anode card 112, whereas frame portions 116b and 116c of portion 110b and 110c are more suited to accommodate anode metal fuel material such as powder, fluid, pellets, fibers, or other material form. Although frame portions 116b and 116c are shown with a singular support/divider, it is within the scope of the present disclosure to include other configurations, such as an open frame portion as in 116a, a grid structure, a perforated structure, or the like.

Referring now to FIG. 1C(ii), the frame portion 116c is shown in greater detail. In particular, frame portion 116c may be molded nearly entirely as a monolithic structure. Frame portion 116c generally includes an outer portion 203 and an integral central support portion 209. The assembly 116c includes a bar structure 201, for example, configured and dimensioned to mechanically cooperate with the central support portion 209. Particularly, support bar structure 201 includes apertures 217, which mechanically cooperate with corresponding raised portions 215 positioned on central portion 209, generally to secure the current collector 114 in frame portion 116c. Further located on bar structure 201 are plurality of gaps 213. These gaps 213, when the bar structure 201 and the central portion 209 are assembled, form central apertures by virtue of gaps 211 and 213 on the support structure 209 and bar structure 201, respectively. There spaces allow for equal distribution of metal fuel material, which can be added during assembly of 110c, or thereafter. Further the spaces improve electrolyte distribution after electrolyte introduction, described further herein.

A further characteristic frame portion of 116c is an inner groove 221 which allow placement of current collect 114 within frame 203. Protruding from frame 203 is a terminal structure 205, have an aperture 207, which allows the negative terminal 122 of the current collect 114 to egress. At the opposite end of frame 203 is a large aperture 219c for facilitating metal fuel introduction during certain manufacturing processes, and for facilitating electrolyte entry into the dry component structure 110c.

Another feature of the frame 203, included to facilitate assembly of a multiple cell structure, are optional guide bosses 223, which may be used during assembly described further herein, to temporally secure dry component structure 110c to a mold and further to enhance structural integrity of an assembled plurality of cells.

Referring now to FIG. 1D, another embodiment of an inner dry component portion is provided. In this embodiment, the ends of a frame portion 116d include two apertures 219d, generally for facilitating metal fuel and/or electrolyte entry into frame portion 116d. Another embodiment of an inner dry component portion is provided is provided in FIG. 1E, wherein a frame portion 116eincludes one aperture 219e for facilitating metal fuel and/or electrolyte entry into frame portion 116e.

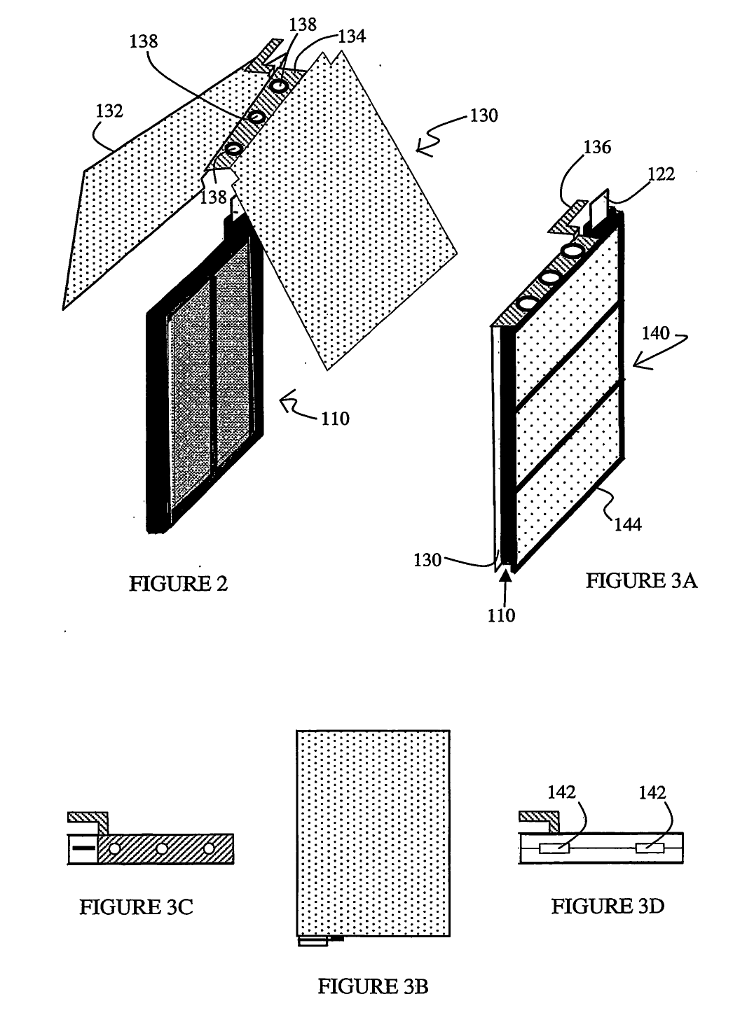

Referring now to FIG. 2, a cathode assembly 130 is shown in relation to the inner dry component portion 110. The cathode assembly 130 is generally wrapped around the inner dry component portion 110 to form an electrode structure of a metal air electrochemical cell.

The assembly 130 includes cathode portions 132, a current collector portion 134, and a cathode terminal 136. Further, as depicted, assembly 130 includes a plurality of rivets 138 within the current collector 134; however, these rivets are not necessary. In the preferred embodiment depicted, these rivets 138 are provided for increased structural support, particularly when both portions 132 are formed from a single continuous sheet of cathode material.

Referring now to FIGS. 3A, 3B, 3C and 3D, isometric, front, top, and bottom (as oriented in FIGS. 3A and 3B) views of a complete dry component structure 140, respectively, are shown. Further, an optional outer cathode frame portion 144 is provided over each cathode portion 132.

Referring to FIG. 3D, optional openings 142 are shown, which may, in certain embodiments, be used to fill voids 113 in an inner dry component structure 110b with dry metal fuel material and/or to facilitate electrolyte introduction.

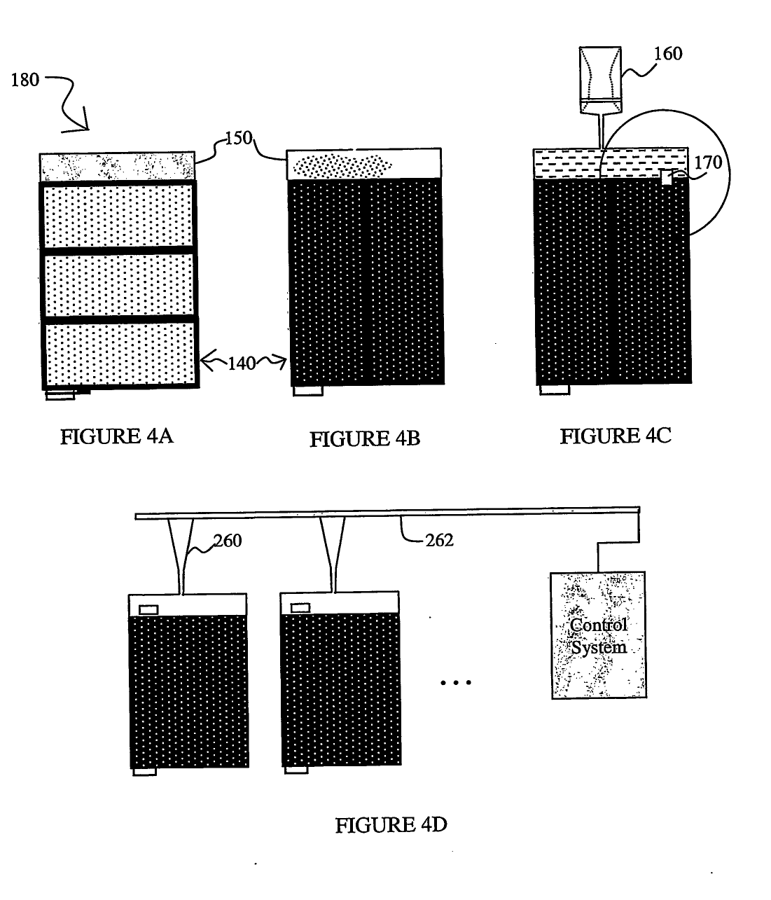

Referring now to FIGS. 4A, 4B and 4C, the dry component structure 140 is shown in relation to a concentrated electrolyte reservoir portion 150. The electrolyte reservoir portion 150 is generally formed on the end of the structure opposition the terminals; that is, the end the shown in FIG. 3D. The reservoir 150 may include some electrolyte of a desired concentration, for example, which may directly be injected into the dry cell component structure 140 thereby activating the cell, or alternatively the reservoir 150 may include a concentrated electrolyte, such as a dry electrolyte. Where electrolyte of a suitable concentration for direct introduction into the dry component structure is provided, various introduction mechanisms may be used.

In a preferred embodiment herein, the electrolyte reservoir 150 includes concentrated electrolyte, in the form of powder or pellets (e.g., potassium hydroxide powder or pellets) or a highly concentrated liquid or gel solution. This concentrated electrolyte may be diluted by introduction of water or other suitable liquid. For example, FIG. 4B shows a section of the dry component cell structure 140 and an electrolyte reservoir 150 including a quantity of powder, for example, potassium hydroxide powder. Referring now to FIG. 4C, a bottle or other water source 160 is used to introduce a quantity of water into the electrolyte reservoir 150 to dilute the electrolyte to the desired concentration. For example, for a metal air electrochemical cells, particularly those using zinc as the anode material and potassium hydroxide as the electrolyte, the solution should be diluted to about 50 percent, or less, depending on the desired voltage and/or current output of the cell assembly formed from a plurality of such cells, or a singular cell.

When using a solid electrolyte such as potassium hydroxide as the concentrated electrolyte, it is desirable to allow the electrolyte solution to dilute to less than about 50 percent potassium hydroxide in water. Note that this reaction (between water and potassium hydroxide) is exothermic, thus the system is suited for usage under cold conditions without external heat. In order to accomplish this, an electrolyte flow control device, structure, or system 170 is provided. This electrolyte flow control device, structure or system 170 may be embodied in various forms, as described further herein.

In another embodiment, as shown in FIG. 4D, the water source may also be operably connected to a control device to allow for automated activation of one or more cells. A single water source 262 may feed the cells, individually or in combination, via ports 260 when operation is required, as determined by the control system. Such a system may be used, for example, as a back-up system in lighting applications, communication systems, or as high power sources (as is known for metal air cells) in backup power systems. Examples of such backup are disclosed, for example, in U.S. patent application Ser. No. 10/045,896 filed Oct. 9, 2001 entitled “Selectively Activated Electrochemical Cell System”, which is incorporated by reference herein in its entirety.

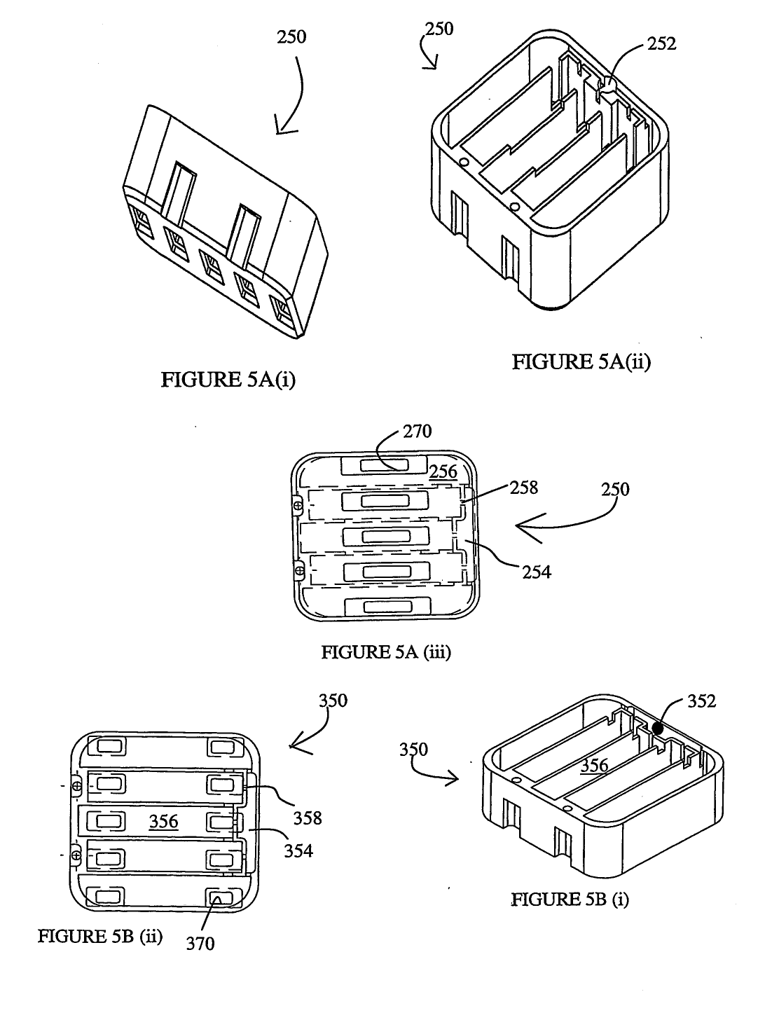

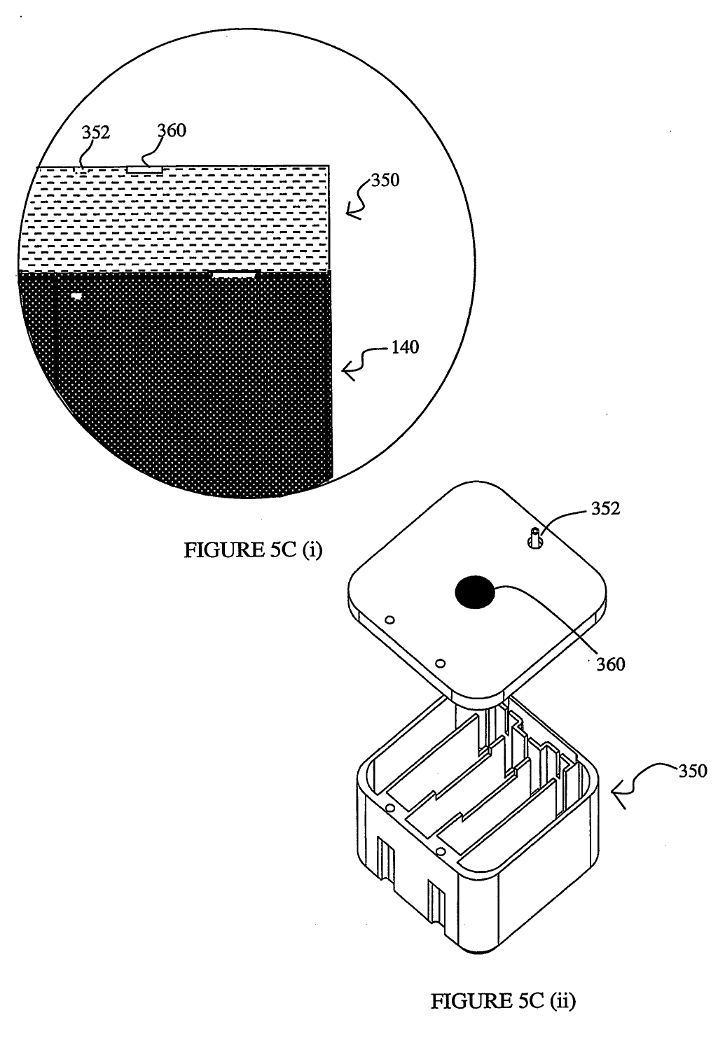

Referring now to FIGS. 5A(i)-5A(iii), bottom isometric, top isometric, and top plan views of an exemplary reservoir 250 are shown. The reservoir 250 includes an inlet 252 for inputting water or other suitable liquid to a distribution area 254, whereby liquid flows into the plural reservoir regions 256 via apertures 258. The plural reservoir regions 256 may each include dry electrolyte such as a KOH pellets that will form a suitable liquid electrolyte solution as described above. The mixed liquid electrolyte may directly enter the dry component structures via an aperture 270, or alternatively with an electrolyte control structure described herein. In further embodiments, the aperture 270 can be utilized to introduce metal fuel material during assembly.

Referring now to FIGS. 5B(i)-5B(ii), top isometric and top plan views of a reservoir 350 are shown. The reservoir 350 includes an inlet 352 for inputting water or other suitable liquid to a distribution area 354, whereby liquid flows from each of the plural reservoir regions 356 via apertures 358.

Referring now to FIGS. 5C(i) and 5C(ii), an electrolyte reservoir 350 includes an inlet 352 at the apex of the reservoir 350, which is an inlet for a water bottle. Further, a pressure release plug 360 is provided to allow release of air from the reservoir 350. Plug 360 preferably prevents the release of H₂O from the reservoir. A preferred material for the plug 360 is polytetrafluoroethylene (Teflon®), however any suitable material that allows air release and prevents water release may be used. As water is introduced into the reservoir 350, air may be expelled from the reservoir through plug 360. Further, pressure that may build up in the reservoir during mixing of the liquid and the electrolyte concentrate can also be expelled.

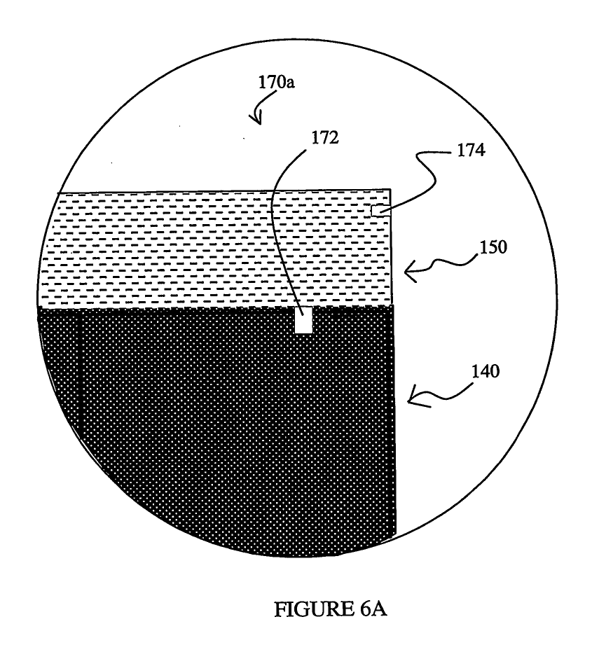

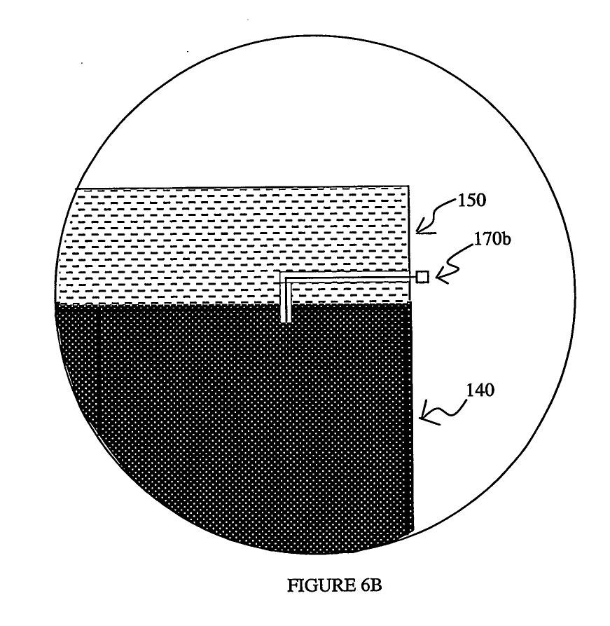

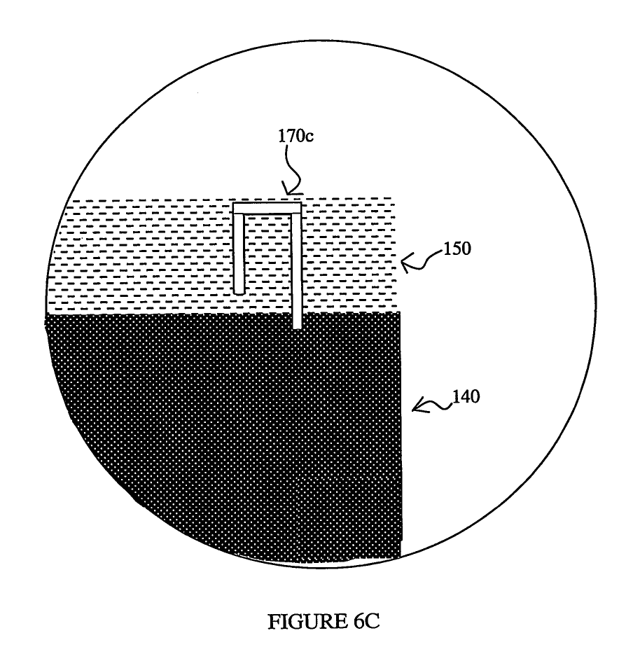

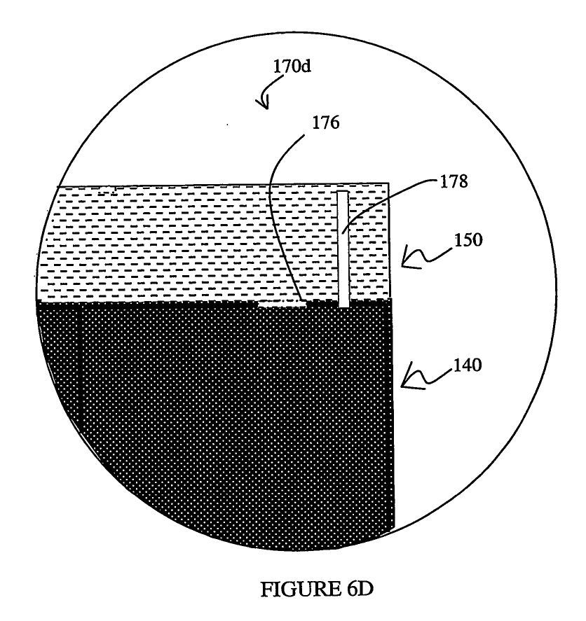

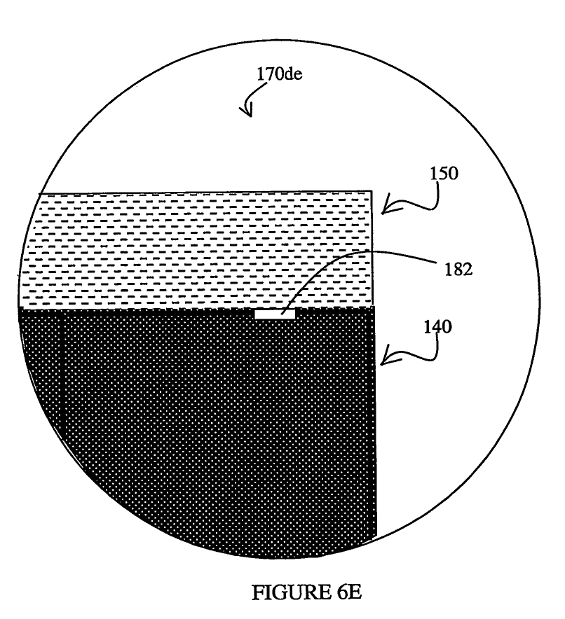

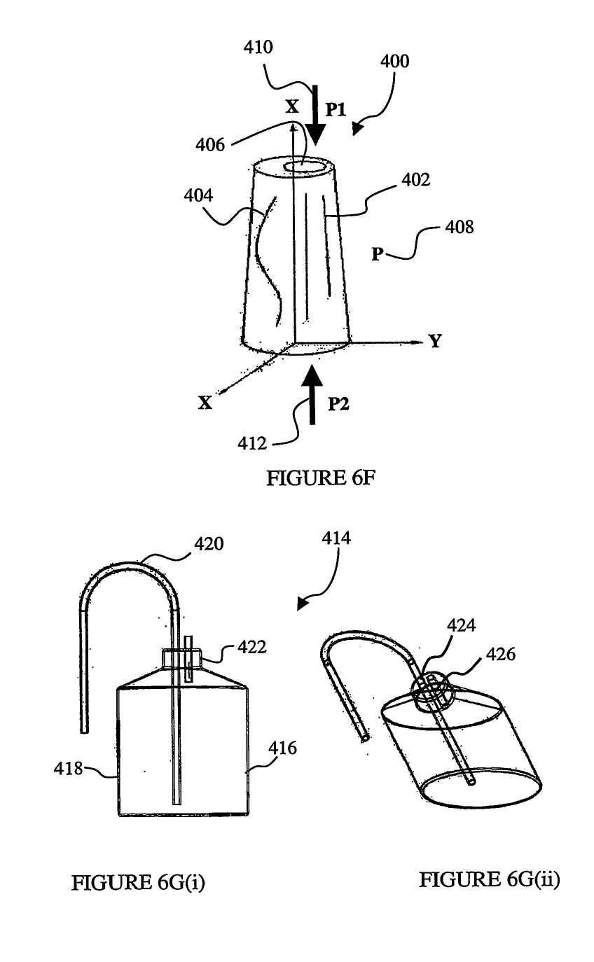

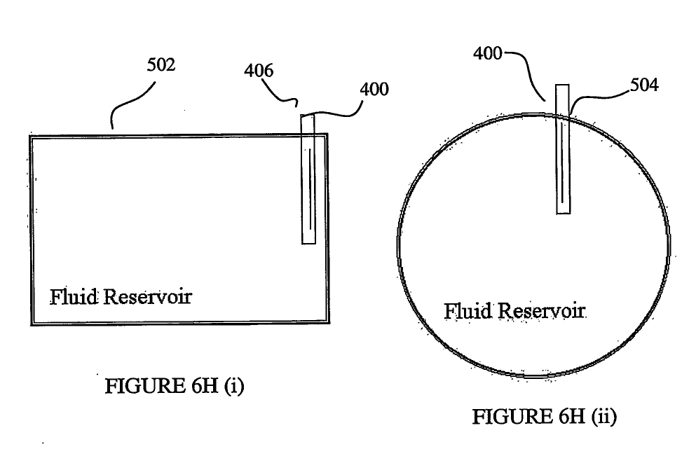

Referring now to FIG. 6A, an electrolyte control structure 170a may be realized in the form of an opening 172 between the reservoir 150 and the dry component structure 140, and another optional air vent opening 174, for example, at a level high enough on the reservoir 150 such that fluid does not leak therefrom.

Referring now to FIG. 6B, an electrolyte control structure 170b is realized in the form of a controllable one-way valve. The valve may be controlled manually, for example, with a simple action of an operably connected lever, or automatic, for example, via a controller driven system.

Referring now to FIG. 6C, an electrolyte flow control structure 170c is realized in the form of a substantially the upside down J-shaped tube providing fluid communication between the interior of the electrolyte reservoir 150 and the dry cell component structure 140. With this tube, electrolyte will not be introduced into the dry component structure 140 until liquid within the J-shaped tube reaches a requisite height level within the reservoir 150. Further, external air pressure may also be required to rapidly transfer the fluid from the reservoir 150 to the dry component structure 140 for cell activation.

Referring now to FIG. 6D an electrolyte flow control structure 170d is realized in the form of an opening 176 between the reservoir 150 and the dry component structure 140. Furthermore is a conduit 178 extending upwardly from the bottom of the reservoir 150. As electrolyte fluid from the reservoir 150 fills the dry component 140 via opening 176, air from the dry component is released through the conduit 178. As air is released from the dry component structure 140, space is created in the dry component 140 to accommodate more electrolyte from reservoir 150 during activation.

Referring now to FIG. 6E an electrolyte flow control structure 170e is realized in the form of an opening 182 between the reservoir 150 and the dry component structure 140. The opening 182 of dry component structure 140 is covered with a separator, for example comprising materials described below with respect to the separator used in the dry component structure. In preferred embodiments, the separator comprises nylon having a porosity that delays liquid introduction into the dry component structure, allowing KOH to thoroughly mix within the reservoir 150 before it fills the dry component structure 140 for activation.

Referring now to FIG. 6F, an embodiment of a one way valve is shown that may be, for example, associated with a bottle or other container with water for introduction into the dry electrolyte reservoir. A tube 400 of a flexible material (e.g., flexible plastic) with one or more cracks on the peripheral wall is shown. The cracks 402 and 404 may be different shapes, and may have constant or variable outer dimensions or inner dimensions along longitudinal axis. The tube has a total length, constant or variable diameter, and constant or variable wall thickness.

To control fluid flow, any one or more of the following may be manipulated: dimensions and property of tube inlet 406 (e.g., dimension of the opening, opening blockage); pressures P408, P1 410 and P2 412, wall cracks 402 and 404 position, configuration, and dimension. Variation of one or more of the above properties allows internal fluid to leak from inside of the tube 400 to the outside of the tube 400 through the wall crack(s) 402 and 404, and further fluid is prevented from leaking back from the outside of the tube 400 to the inside of the tube 400.

For example, one end of tube 400 can be blocked to manipulate its tube 400 properties and the pressure P1 410 or P2 412. Thus, fluid within the tube 400 leaks through the wall cracks 402 and 404 to the outside of the tube 400, while fluid is prevented from leaking back from the outside of the tube 400 to the inside of the tube 400.

Used in juxtaposition with tube 400 is a bottle 414, which continuously supplies liquid as shown in FIGS. 6G(i) and 6G(ii). A flexible bottle 414 can load liquid and be pressed or squeezed on its peripheral wall(s) 416 and 418 to supply liquid. An elongated hollow tube 420 allows liquid to flow through for liquid supply. A one-way tube 400 such as that in FIG. 6F, allows ambient air to leak through, into bottle 414 to prevent liquid from being sucked back out of the bottle 414. A cap 422 includes two holes 424 and 426, one for a water supply tube 420 and the other for the one-way tube 400.

When one-way tube 400 is used, one end of tube 400 is blocked and the other end is opened to allow ambient air inside. Adequate wall crack(s) 402 and 404 are formed on the peripheral walls of the tube 400. These wall cracks 402 and 404 are used to ventilate air from the outside to the inside of the bottle 414.

Referring now to FIG. 6H(i) an embodiment of a fluid reservoir system is shown. A container 502 has a generally constant volume and a one-way tube 400, as described above, for example, with respect to FIGS. 6F, 6G(i) and 6G(ii). The fluid reservoirs 500 may be filled with fluid through the one-way valve.

Referring now to FIG. 6H(ii) another embodiment of a fluid reservoir 500 is shown, wherein the fluid reservoir is in the form of a variable volume container 504 (e.g., formed of flexible material). The reservoir 500 includes a one-way tube 400, as described above, for example, with respect to FIGS. 6F, 6G(i) and 6G(ii). The reservoir 500 can be filled by supplying fluid through inlet 406 of the one-way tube 400, whereby the reservoir 500 remains filled or inflated, as the one-way tube 400 prevents leakage, since one end of the tube 400 is blocked and fluid fills through the cracks 402 and 404. Further, as described above, the fluid(s) inside of the fluid reservoir 500 are prevented from leaking out with the inclusion of the one-way tube 400. The flexibility of the container 504 resists internal pressure build-up.

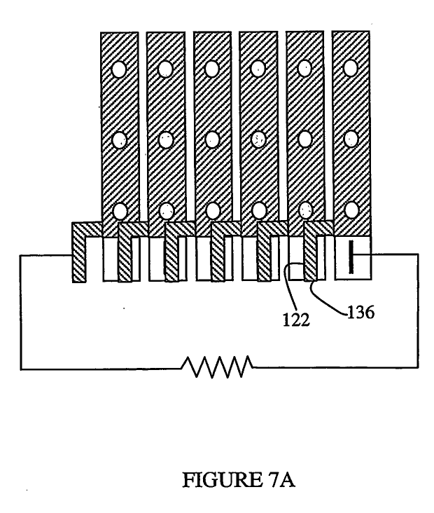

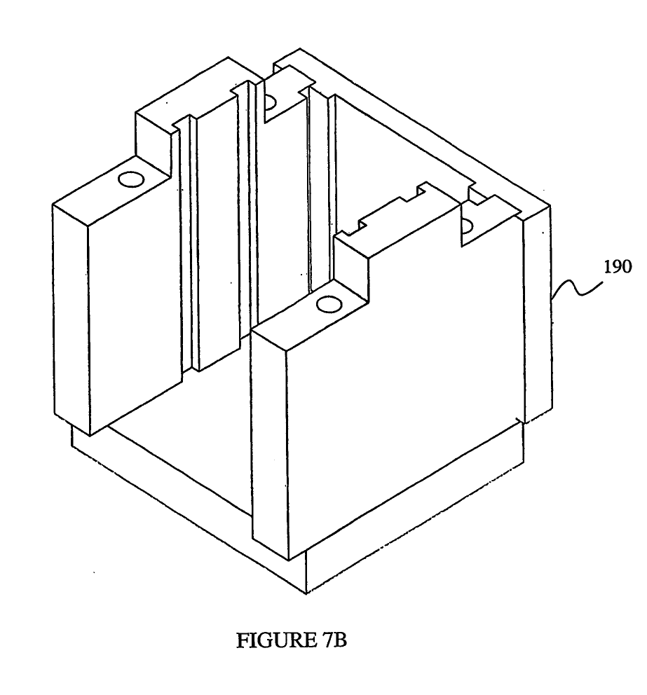

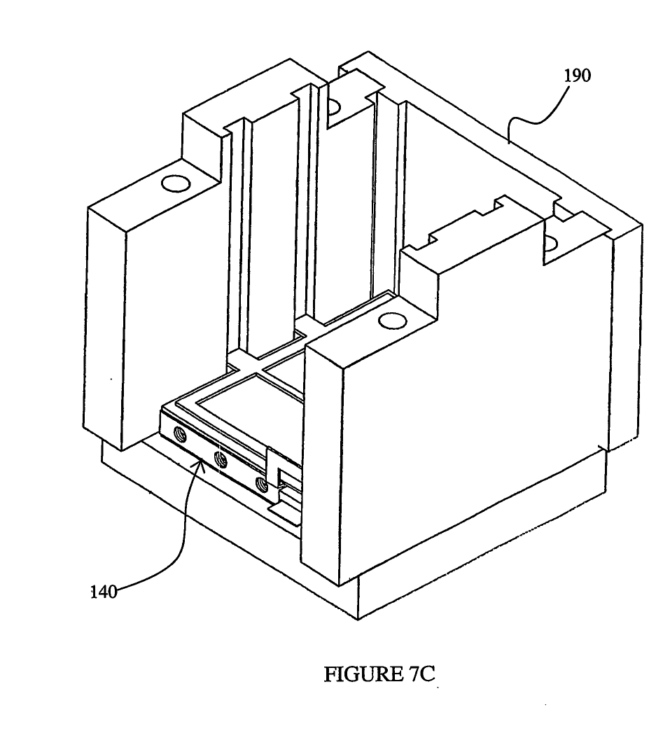

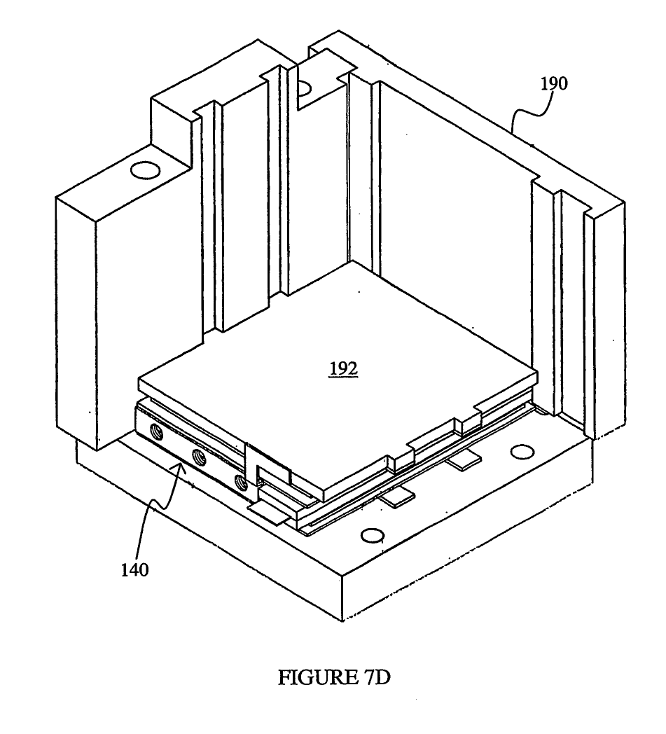

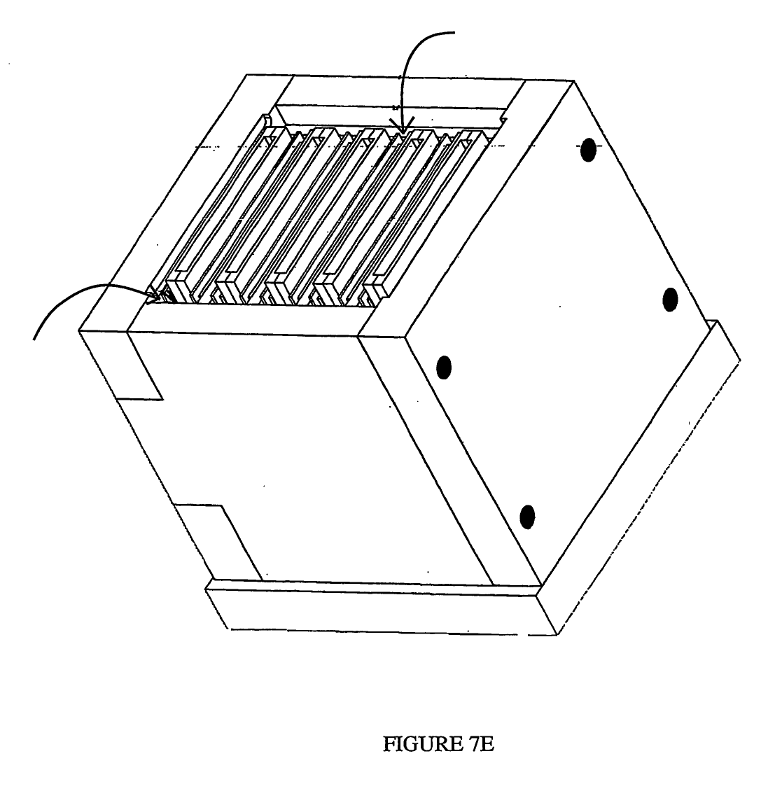

Referring now to FIG. 7A, a plurality of reserve cells 180 may be assembled in a series configuration. In particular, the configuration and dimensions of the anode terminal 122 and the cathode terminal 136 facilitate series connection, by soldering or otherwise electrically connecting adjacent anode and cathode terminals. Note that the L-shaped cathode terminal 136 abuts the extending anode terminal 122 (extending normal to the plane of the page in the Figure). FIG. 7 shows five cells in series; however, it is understood that fewer or more cells may be used desired depending on the desired voltage. Further, the cells may be arranged in parallel to increase the current output, as needed.

In one embodiment, a set of five reserve cells 180, particularly metal air reserve cells, are arranged in the configuration of a typical lantern battery.

Referring now to FIGS. 7B, 7C, 7D and 7E, various steps for molding, pour casting or otherwise integrally forming a unitary structure from a plurality of cells, for example as configured in FIG. 7, are shown. Although reference is made herein to the reserve battery described in this disclosure, the technique described with respect to FIGS. 7B, 7C, 7D and 7E may be expanded to other types of electrochemical cells, particularly metal air electrochemical cells. FIG. 7B shows a portion of a mold 190 configured for receiving five reserve cells 180. Referring now to FIG. 7C, one dry component structure 140 is placed in the molds 190. Note that the protrusions on the cell frame may be aligned with corresponding grooves on the inside wall of the molds 190. Referring now to FIG. 7D, wherein one wall of the mold 190 is removed in the Figure for clarity, a spacer 192 is provided adjacent to structure 140. The spacer 192 allows for airflow to access the cathode portions 132 during usage after casting or molding, as described herein. Further, the spacer covers the main air access portion of the cathode, while leaving exposed the outer edge portions of the cathode portions.

Referring now to FIG. 7E, a plurality of structures 140 are assembled within the molds 190. Once component structures 140 with spacers 192 are assembled the molds 190 is closed on all sides except for the surface opposite the terminals. Accordingly, prior to full assembly of the mold 190, the terminals are soldered or otherwise electrically connecting as desired. Further the molds 190 will be cast by various types of molding such as injection molding, pour casting, spin casting, or other molding or casting techniques.

As indicating in FIG. 7E with a pair of arrows, various locations for pour casting materials are available. Accordingly, the five individual cells may be pour casted into an integral battery structure, minimizing or eliminating leakage, and further insulating the conductive terminals of the cells.

In another embodiment (not shown), the mold may be configured and dimensioned to hold the reservoir structure. Thus, during casting of the cells, the reservoir structure may be integrally cast with the dry cell components.

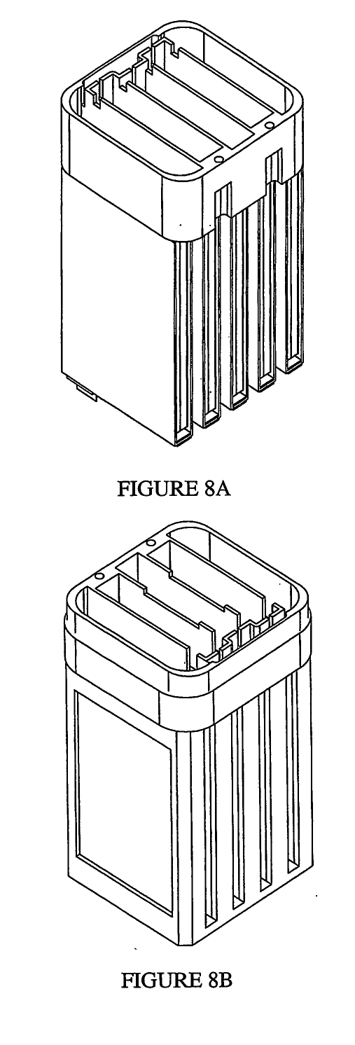

Referring to FIG. 8A, the dry cell components and the reservoir structure are shown prior to casting. FIG. 8B shows a cell after casting, e.g. with a mold as described with respect to FIGS. 7B-7E. For example, injection molding, pour casting, spin casting, or other molding or casting techniques may be employed.

In preferred embodiments, the shell is allowed to polymerized in situ (as opposed to allowing a molten material to set). Monomers may be selected for in situ polymerization, thereby allowing polymerization and possibly cross-linking within, for example, the pores of the cathode to form a tight seal, thereby illuminating electrolyte leakage, and providing structural binding and support for all of the cell components within each dry cell structure 140 and between the several cell structures 140. A preferred type of material includes urethanes that polymerize in situ at low temperatures and low pressures, preferably ambient temperatures and pressures. Further, preferred materials resist shrinkage (i.e., minimal or no shrinkage during curing). One such material is TEK plastic polyurethane (TAN) commercially available from Tekcast Industries, Inc. New Rochelle, N.Y. (manufactured by Alumilite Corporation, Kalamazoo, Mich.).

Note that when a plurality of cells is provided, it may be desirable to use a single electrolyte reservoir structure 150. However, in certain embodiments, the reservoir structure 150 should be provided such that each electrochemical cell's dry component structure 140 has an associated reservoir portion, as shown in FIGS. 5A(i)-5B(ii). This will generally prevent short circuit across multiple cells. However, in other embodiments, such as shown in FIG. 6C, separate reservoir portions are not required, as the path in each structure 170c provides sufficient resistance to minimize the effects of short-circuiting between cells.

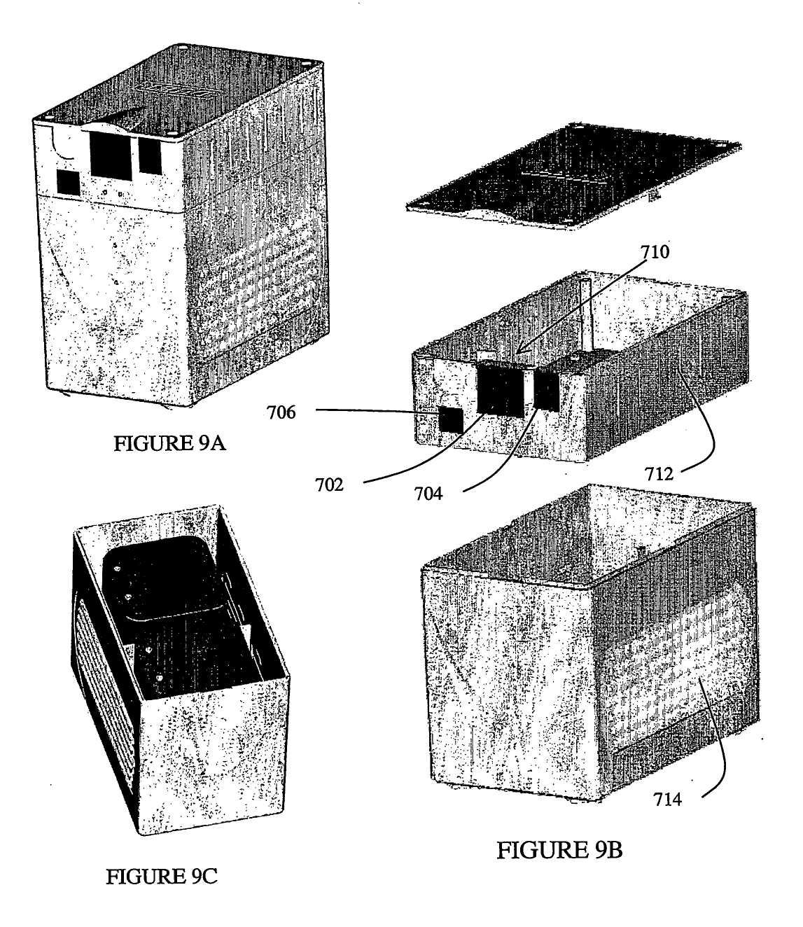

In one embodiment, a reserve cell 180, particularly metal air reserve cells, are used in the configuration with a portable power supply system, as shown in FIGS. 9A-9C. The portable power supply system is particularly suitable, for example, for use with reserve batteries, as described heretofore.

In general, the portable power supply system according to the present invention, serves as an AC power supply unit with one or more replaceable batteries integrated therein. In preferred embodiments, the batteries include reserve metal air batteries as described herein.

The power supply system may include an AC power outlet 702 allowing a user to directly plug in electrical or electronic devices; an on-off switch 704 to control operation of the system; and a light bulb 706 integrated therein for lighting purpose, wherein the light bulb uses DC power directly from the primary or reserve batteries 180. In the upper portion for housing the DC-AC converter 710 and associated circuitry, air vents 712 are provided to allow for cooling from ambient air. Further, in the electrochemical cell, housing portion, a plurality of louvers 714 are provided to allow for cooling from ambient air. Note that these louvers may be stationary, or alternatively may be movable. In the case of movable louvers, a preferred embodiment includes load sensing circuitry to detect the presence of a load, whereby the louvers 714 open only when a load is present by a suitable motion control means. This is particularly desirable in a system using metal air cells, since isolation from ambient air (one of the “consumable” electrode materials in metal air cell chemistry) prolongs cell lifetime.

Note that the DC-AC converter 710 used in the present invention is integrated in a reusable housing for integration with a primary or reserve battery 180 in a separate housing. This allows continued use of the portable power supply system upon replacement of consumed batteries. Preferably, all of the housings (for the DC-AC converter 710 and the batteries) are constructed of materials that withstand cracking and melting (during extreme usage conditions), and further the components are integrated therein (i.e., the DC-AC converter 710 and the batteries) in a manner as to minimize shock in the event that the power supply unit is dropped or otherwise subjected to shock impact.

The system is readily portable, and may be even more readily portable with the inclusion of a carrying bag designed to store the integrated system for portability, and optionally an additional outside bag or pouch within the carrying bag for storing an AC adapter associated with an electronic device.

To operate the power supply system, a pair of batteries, for example primary batteries or reserve batteries 180, are provided with connecting wires that connect to the DC-AC converter (after activation of the reserve battery). Thereafter, the DC-AC housing is attached to the cell housing and may be secured together with a suitable locking mechanism, such as a flip lock. Thereafter, the system is ready to power typical AC devices, including but not limited to household appliances, personal computers, notebook computers, televisions, portable electronics, cellular telephones, and electric tools.

In another embodiment, the power supply provided DC power. For example, a 12 volt nominal system includes a DC to DC converting system capable of accepting an input voltage ranging from about 7 volts to about 15 volts to maximize energy conversion from one or more removable associated primary or reserve batteries 180. Thus, as the voltage of the battery drops due to extended use, additional energy may be used from the battery until the voltage output drops to about 7 volts. The DC-DC converter compensates any voltage or power requirements of associated devices.

In further embodiments, the portable power supply may include a fan integrated therein, wherein the fan may be controlled by a temperature sensor for efficient heat dissipation and air circulation.

The portable power supply may also include an overload protection system, a short circuit protection system, an over temperature protection system, and the like, wherein the system may automatically shut down upon detection of any of the above conditions, or alternatively lowers the power output until satisfactory operating conditions are met.

Having thus described the components of various embodiments of the present invention, various materials for the electrochemical cell will be described hereinafter.

The anode material generally comprises a consumable metal constituent in card, powder, liquid, or other desired form. Optionally an ionic conducting medium is provided within the anode. Further, in certain embodiments, the anode comprises a binder and/or suitable additives. Preferably, the formulation optimizes ion conduction rate, capacity, density, and overall depth of discharge, while minimizing shape change during cycling.

The metal constituent may comprise mainly metals and metal compounds such as zinc, calcium, lithium, magnesium, ferrous metals, aluminum, oxides of at least one of the foregoing metals, or combinations and alloys comprising at least one of the foregoing metals. These metals may also be mixed or alloyed with constituents including, but not limited to, bismuth, calcium, magnesium, aluminum, indium, lead, mercury, gallium, tin, cadmium, germanium, antimony, selenium, thallium, oxides of at least one of the foregoing metals, or combinations comprising at least one of the foregoing constituents. The metal constituent may be provided in the form of powder, fibers, dust, granules, flakes, needles, pellets, or other particles. In certain embodiments, granule metal, particularly zinc alloy metal, is provided as the metal constituent. During conversion in the electrochemical process, the metal is generally converted to a metal oxide.

The anode current collector may be any electrically conductive material capable of providing electrical conductivity and optionally capable of providing support to the anode material or card. The current collector may be formed of various electrically conductive materials including, but not limited to, copper, brass, ferrous metals such as stainless steel, nickel, carbon, electrically conducting polymer, electrically conducting ceramic, other electrically conducting materials that are stable in alkaline environments and do not corrode the electrode, or combinations and alloys comprising at least one of the foregoing materials. The current collector may be in the form of a mesh, porous plate, metal foam, strip, wire, plate, or other suitable structure.

The optional binder of the anode primarily maintains the constituents of the anode in a solid or substantially solid form in certain configurations. The binder may be any material that generally adheres the anode material and the current collector to form a suitable structure, and is generally provided in an amount suitable for adhesive purposes of the anode. This material is preferably chemically inert to the electrochemical environment. In certain embodiments, the binder material is soluble, or can form an emulsion, in water, and is not soluble in an electrolyte solution. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

Optional additives may be provided to prevent corrosion. Suitable additives include, but are not limited to indium oxide; zinc oxide, EDTA, surfactants such as sodium stearate, potassium Lauryl sulfate, Triton® X400 (available from Union Carbide Chemical & Plastics Technology Corp., Danbury, Conn.), and other surfactants; the like; and derivatives, combinations and mixtures comprising at least one of the foregoing additive materials. However, one of skill in the art will determine that other additive materials may be used.

The oxygen supplied to the cathode may be from any oxygen source, such as air; scrubbed air; pure or substantially oxygen, such as from a utility or system supply or from on site oxygen manufacture; any other processed air; or any combination comprising at least one of the foregoing oxygen sources.

The cathode portions may be a conventional air diffusion cathode, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm2), preferably at least 50 mA/cm2, and more preferably at least 100 mA/cm2. Of course, higher current densities may be attained with suitable cathode catalysts and formulations. The cathode may be a bi-functional, for example, which is capable of both operating during discharging and recharging. However, utilizing the systems described herein, the need for a bi-functional cathode is obviated, since the third electrode serves as the charging electrode.

The carbon used is preferably be chemically inert to the electrochemical cell environment and may be provided in various forms including, but not limited to, carbon flake, graphite, other high surface area carbon materials, or combinations comprising at least one of the foregoing carbon forms.

The cathode current collector may be any electrically conductive material capable of providing electrical conductivity and preferably chemically stable in alkaline solutions, which optionally is capable of providing support to the cathode 14. The current collector may be in the form of a mesh, porous plate, metal foam, strip, wire, plate, or other suitable structure. The current collector is generally porous to minimize oxygen flow obstruction. The current collector may be formed of various electrically conductive materials including, but not limited to, copper, ferrous metals such as stainless steel, nickel, chromium, titanium, and the like, and combinations and alloys comprising at least one of the foregoing materials. Suitable current collectors include porous metal such as nickel foam metal.

A binder is also typically used in the cathode, which may be any material that adheres substrate materials, the current collector, and the catalyst to form a suitable structure. The binder is generally provided in an amount suitable for adhesive purposes of the carbon, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® and Teflon® T-30 commercially available from E.I. du Pont Nemours and Company Corp., Wilmington, Del.), polyvinyl alcohol (PVA), poly(ethylene oxide) (PEO), polyvinylpyrrolidone (PVP), and the like, and derivatives, combinations and mixtures comprising at least one of the foregoing binder materials. However, one of skill in the art will recognize that other binder materials may be used.

The active constituent is generally a suitable catalyst material to facilitate oxygen reaction at the cathode. The catalyst material is generally provided in an effective amount to facilitate oxygen reaction at the cathode. Suitable catalyst materials include, but are not limited to: manganese, lanthanum, strontium, cobalt, platinum, and combinations and oxides comprising at least one of the foregoing catalyst materials. An exemplary air cathode is disclosed in U.S. Pat. No. 6,368,751, entitled “Electrochemical Electrode For Fuel Cell”, to Wayne Yao and Tsepin Tsai, which is incorporated herein by reference in its entirety. Other air cathodes may instead be used, however, depending on the performance capabilities thereof, as will be obvious to those of skill in the art.

To electrically isolate the anode from the cathode, a separator is provided between the electrodes, as is known in the art. The separator may be any commercially available separator capable of electrically isolating the anode and the cathode, while allowing sufficient ionic transport therebetween. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, nylon, polyolefin (e.g., Gelgard® commercially available from Dow Chemical Company), polyvinyl alcohol (PVA), cellulose (e.g., nitrocellulose, cellulose acetate, and the like), polyethylene, polyamide (e.g., nylon), fluorocarbon-type resins (e.g., the Nafion® family of resins which have sulfonic acid group functionality, commercially available from du Pont), cellophane, filter paper, and combinations comprising at least one of the foregoing materials. The separator may also comprise additives and/or coatings such as acrylic compounds and the like to make them more wettable and permeable to the electrolyte.

While preferred embodiments have been shown and described, various modifications and substitutions may be made thereto without departing from the spirit and scope of the invention. Accordingly, it is to be understood that the present invention has been described by way of illustrations and not limitation.

1. A structure for use in an electrochemical cell system comprising:
a dry component structure including a plurality of dry components, including an anode and a cathode, one end of the dry component structure having a reservoir of electrolyte concentrate,
wherein liquid is added to the reservoir of electrolyte concentrate and electrolyte is introduced into the dry component structure through an electrolyte flow control structure thereby causing electrochemical reaction between the anode and cathode.

2. The structure as in claim 1, wherein the electrolyte flow control structure comprises tubing configured, dimensioned and positioned to allow fluid to fill to a requisite level in the reservoir prior to being introduced en mass intro the dry component structure.

3. The structure as in claim 2, further wherein air is introduced after liquid is added to the requisite level to facilitate fluid transfer from the reservoir to the dry component structure.

4. The structure as in claim 1, wherein the electrolyte flow control structure comprises an opening between the reservoir and the dry component structure and a plug at a top portion of the reservoir, wherein the plug is formed of a material capable of allowing air to exit the reservoir and capable of preventing fluid from passing therethrough.

5. The structure as in claim 1, wherein the electrolyte flow control structure comprises a controllable one-way valve.

6. The structure as in claim 1, wherein the electrolyte flow control structure comprises an upside down J-shaped tube, wherein the J-shaped tube provides fluid communication between interior of electrolyte reservoir and dry component structure, whereby electrolyte will not be introduced into the dry component structure until liquid in the tube reaches a requisite height in reservoir.

7. The structure as in claim 1, wherein the electrolyte flow control structure comprises an opening between the reservoir and dry component structure and a conduit extending from the reservoir to ambient, wherein electrolyte fluid from reservoir fills the dry components and air is released from the reservoir.

8. The structure as in claim 1, wherein the electrolyte flow control structure comprises an opening covered with a separator.

9. The structure as in claim 8, wherein separator is fabricated of nylon.

10. The structure as in claim 9, wherein the nylon has a porosity that delays liquid introduction into dry cell, whereby electrolyte is allowed to at least partially mix within the reservoir, before entering dry component structure.

11. A structure for use in an electrochemical cell system comprising:
an assembly including a plurality of dry component portions, each dry component portion including an anode and a cathode, one end of the dry component structure having a reservoir of electrolyte concentrate.

12. The structure as in claim 11, wherein liquid is introduced via an inlet; the inlet in fluid communication with a distribution area, the reservoir including a region associated with each dry component portion.

13. The structure as in claim 11, wherein each dry component structure includes an anode current collector having opposing sides, an anode card on each side of the anode current collector, and a cathode portion associated with each anode card.

14. The structure as in claim 11, wherein each dry component structure includes an anode current collector having opposing sides, an anode frame configured for holding anode material in electrical contact with the anode current collector, and a cathode portion associated with the anode material.

15. The structure as in claim 14, wherein the anode frame is a monolithic structure having a central support portion and a peripheral portion, further wherein the anode current collector is assembled in the anode frame and secured with a separate frame portion that mechanically cooperates with the central support portion.

16. The structure as in claim 15, wherein the assembled structure includes at least one opening between the separate frame portion and the central support portion, the opening facilitating filling of anode material.

17. The structure as in claim 15, wherein the assembled structure includes at least one opening between the separate frame portion and the central support portion, the opening facilitating electrolyte access.

18. The structure as in claim 14, the anode frame having an opening proximate the reservoir, the opening facilitating filling of anode material.

19. The structure as in claim 14, the anode frame having an opening proximate the reservoir, the opening facilitating electrolyte access.

20. A kit for providing energy comprising a structure as in claim 1, further comprising a container having a nozzle configured to introduce water into the dry component portions.

21. A system for providing energy comprising a structure as in claim 1, a water source, and a control system for determining when water should be introduced into the dry component portions.

22. A portable power supply system comprising a housing for a reserve battery as in claim 1 and a reusable housing containing a DC to AC converter system, DC to DC converter system, or both.

23. The portable power supply system as in claim 22, wherein the housing for the reserve battery includes louvers for airflow.

24. The portable power supply system as in claim 22, wherein the housing for the reserve battery includes controllable louvers for airflow when the system is operated.

25. The portable power supply system as in claim 22, further comprising a fan integrated therein.

26. The portable power supply system as in claim 25, wherein the fan is operated when the system is operated.

27. The portable power supply system as in claim 25, wherein the fan is operably coupled to a temperature sensor for operation when the temperature sensor exceeds a desired level.

28. A method of manufacturing a metal air cell comprising:
forming an assembly by providing an anode current collector, surrounding the anode current collector with anode, and placing a cathode proximate to and in electrical isolation from the anode;
placing the assembly in a mold with a spacer positioned to cover an air access portion of the cathode and leaving exposed at least one edge of the cathode; and
casting a curable material in the mold,
whereby the curable material cures within the edge of the cathode.

29. A method of manufacturing a metal air reserve battery comprising:
forming an assembly by providing an anode current collector, surrounding the anode current collector with anode, and placing a cathode proximate to and in electrical isolation from the anode;
placing the assembly in a mold with a spacer positioned to cover an air access portion of the cathode and leaving exposed at least one edge of the cathode; and
casting a curable material in the mold,
whereby the curable material cures within the edge of the cathode.

30. The method as in claim 29, wherein a reservoir is provided in the mold at a distal end of the assembly prior to casting.

31. The method as in claim 29, wherein the curable material comprises urethane resin.

32. The method as in claim 29, wherein the curable material is allowed to polymerize in situ within the pores of the cathode to form a tight seal.

33. The method as in claim 29, wherein the curable material cures at low temperature and low pressure.

34. The method as in claim 29, wherein the curable material cures at ambient temperature.

35. The method as in claim 29, wherein the curable material cures at ambient pressure.

36. The method as in claim 29, wherein the curable material resists shrinkage.

37. A kit for providing energy comprising a structure as in claim 11, further comprising a container having a nozzle configured to introduce water into the dry component portions.

38. A system for providing energy comprising a structure as in claim 11, a water source, and a control system for determining when water should be introduced into the dry component portions.

39. A portable power supply system comprising a housing for a reserve battery as in claim 11 and a reusable housing containing a DC to AC converter system, DC to DC converter system, or both.

40. The portable power supply system as in claim 39, wherein the housing for the reserve battery includes louvers for airflow.

41. The portable power supply system as in claim 39, wherein the housing for the reserve battery includes controllable louvers for airflow when the system is operated.

42. The portable power supply system as in claim 39, further comprising a fan integrated therein.

43. The portable power supply system as in claim 42, wherein the fan is operated when the system is operated.

44. The portable power supply system as in claim 42, wherein the fan is operably coupled to a temperature sensor for operation when the temperature sensor exceeds a desired level.
